(19) United States
(12) Patent Application Publication
(10) Pub. No.: US 2021/0186089 A1
(43) Pub. Date: Jun. 24, 2021

(54) COLLAR

(71) Applicant: Kristian R. Merwin, Salt Lake City, IL (US)

(72) Inventor: Kristian R. Merwin, Salt Lake City, IL (US)

(21) Appl. No.: 16/722,111

(22) Filed: Dec. 20, 2019

(51) Int. Cl. A24F 1/30; A24F 1/32; F16L 21/02

(52) U.S. Cl. CPC A24F 1/30; F16L 21/02; A24F 1/32

(57) ABSTRACT

In one embodiment there is provided a collar to secure a glass component that has a smooth tubular end. The collar being configured to prevent a gas and liquid from leaking from the glass component. The collar has a base with a circular side wall extending from the base. A pair of channels with O-rings are secured into the interior surface of the circular side wall. The O-rings are configured in size such that when the smooth tubular end of the glass component frictionally slips into the first opened end of the collar, the pair of O-rings frictionally engages the smooth tubular end to prevent a leaking of gas or liquid. The collar also has a bore defined through the base with threads to secure in concert with a one or more threaded connectors.

### FIELD OF THE INVENTION

The present invention relates to a collar used to connect components with smooth ends together.

### BACKGROUND OF THE INVENTION

A collar is a simple component found in many machines and applications. A collar is used as a mechanical means to connect two components together. Collars typically have threads or beads which works in connect with opposing threads or beads to secure two components together. There are virtually only a few types of collars available, however, is most circumstances collars used for glass components or components with smooth ends are problematic. Since glass is blown, having threads or beads incorporated into the end of the glass can become a challenge both in terms of having them created uniformly to match a machined collar and in terms of maintaining the seal to avoid leaks and cracks. As such, there is a need to develop a collar that is easy to use with glass components to connect multiple components together. Similarly, when a plastic or other type of component has a smooth end it is difficult to connect these together while maintaining a gas and liquid seal between the two components. When used in toys or for young children the dexterity required to tighten a tiny screw on a shaft collar is virtually impossible without an adult or teenager. Therefore, there is need for a shaft collar that can be easily used when connecting components with smooth ends and without having to blow or create threads or beads on the ends of the components, especially glass components.

### SUMMARY OF THE INVENTION

In one embodiment of the present invention there is provided a collar to secure a glass component thereto, wherein the glass component has a smooth tubular end. The collar being configured to prevent a gas and liquid from leaking from the glass component. The collar includes a base with a circular side wall extending from the base to define a first opened end. A pair of channels are grooved into the interior surface of the circular side wall with a pair of O-rings separately secured within the pair of channels. The O-rings are configured in size such that when the smooth tubular end of the glass component frictionally slips into the first opened end of the collar, the pair of O-rings frictionally engages the smooth tubular end to prevent a leaking of gas or liquid. The collar further has a bore defined through the base. A base surface wall surrounding the bore has threads to secure in concert with a one or more threaded connectors.

In other embodiments, the pair of channels are defined to be equally spaced apart from the base and top portion of the side wall. In addition, the bore can be positioned about a quarter of the distance of the full length of the side wall and configured to accommodate double opposing threaded connectors that are secured into the bore. The bore may also be centrally positioned on the base leaving a circular table on the base between the side wall and the perimeter of the bore.

In a second embodiment a component collar is provided to secure glass components thereto, wherein the glass components have at least one smooth tubular end. The collar being configured to prevent a gas and liquid from leaking from the glass components. The collar includes a base with a first circular side wall extending upwardly from the base to define a first opened end and a second circular side wall extending downwardly from the base to define a second opened end. A side wall channel is grooved into each of the first and second circular side walls. A bore is defined through the base with the base surface wall surrounding the bore having a bore channel grooved into the base surface wall. O-rings are secured within each of the side wall channels and the bore channel. The O-rings are configured in size such that when smooth tubular ends of glass components frictionally slip into the first opened end, second opened end, and bore defined by the collar, the O-rings frictionally engages the smooth tubular ends to prevent a leaking of gas or liquid.

Numerous other advantages and features of the invention will become readily apparent from the following detailed description of the invention and the embodiments thereof, from the claims, and from the accompanying drawings.

### BRIEF DESCRIPTION OF THE DRAWINGS

A fuller understanding of the foregoing may be had by reference to the accompanying drawings, wherein:

FIG. 1 is a perspective view of a first collar in accordance with an embodiment of the invention;

FIG. 2 is an underside perspective view of the first collar;

FIG. 3 is an exploded view of the first collar in accordance with an embodiment of the invention;

FIG. 4 is a cross section view of the first collar;

FIG. 5 is a perspective view of a glass assembly using the first collar in accordance with an embodiment of the invention;

FIG. 6 is a cross sectional view of FIG. 5;

FIG. 7 is an exploded view of the components shown in FIG. 5;

FIG. 8 is a perspective view of a second collar in accordance with an embodiment of the invention;

FIG. 9 is an underside perspective view of the second collar;

FIG. 10 is an exploded view of the second collar in accordance with an embodiment of the invention;

FIG. 11 is a cross section view of the second collar;

FIG. 12 is a perspective view of a glass assembly using the second collar in accordance with an embodiment of the invention;

FIG. 13 is a cross sectional view of FIG. 11; and

FIG. 14 is an exploded view of the components shown in FIG. 12.

### DETAILED DESCRIPTION OF THE DRAWINGS

While the invention is susceptible to embodiments in many different forms, there are shown in the drawings and will be described in detail herein the preferred embodiments of the present invention. It should be understood, however, that the present disclosure is to be considered an exemplification of the principles of the invention and is not intended to limit the spirit or scope of the invention and/or claims of the embodiments illustrated.

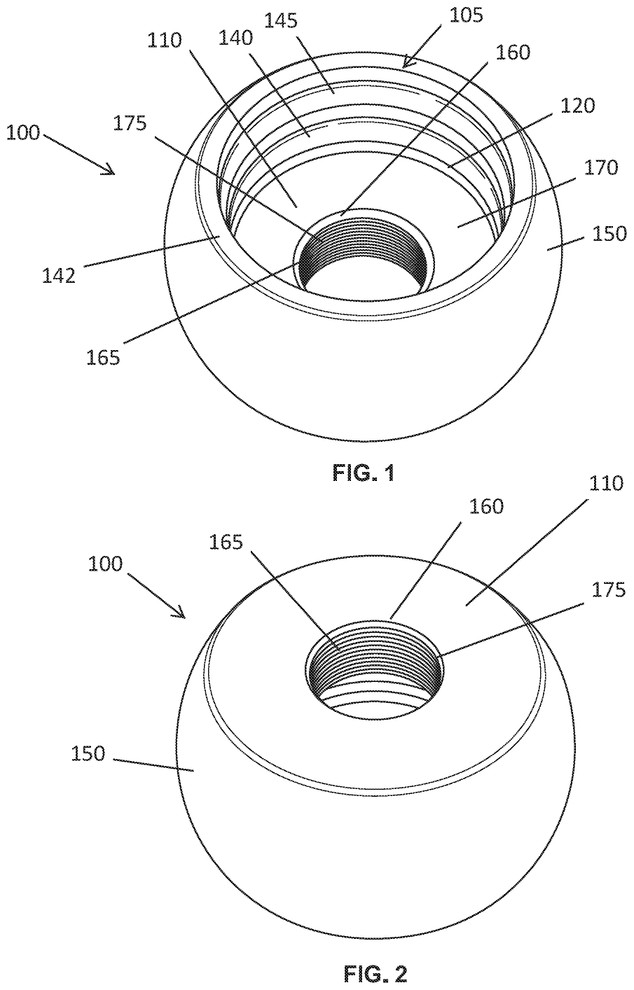

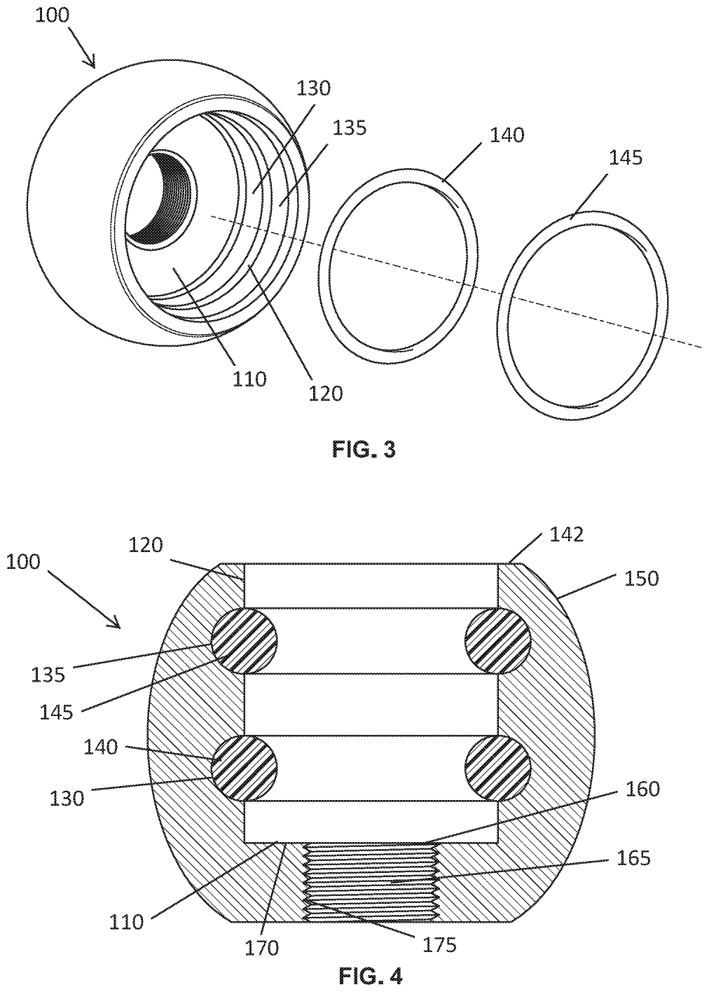

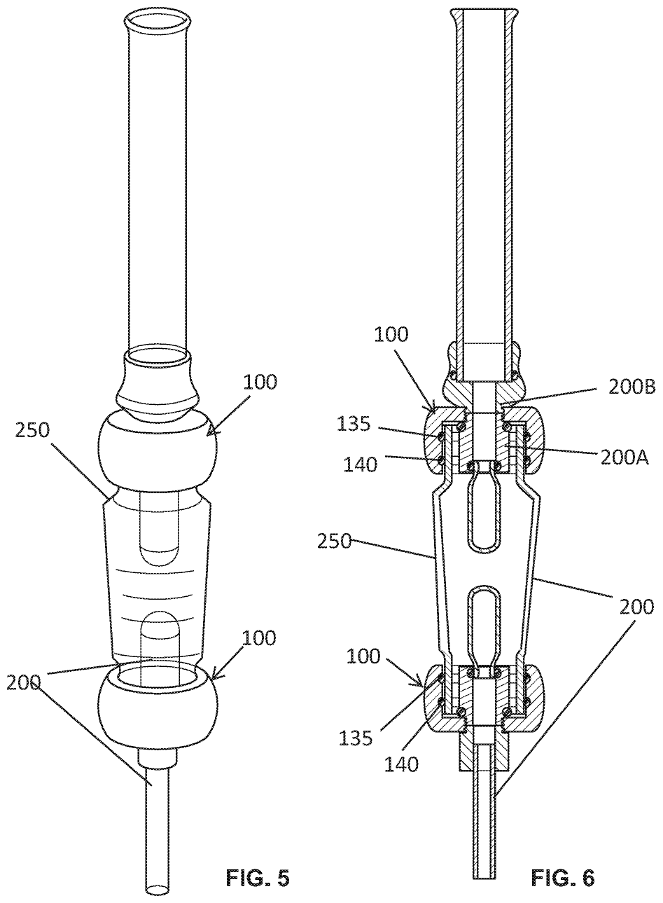

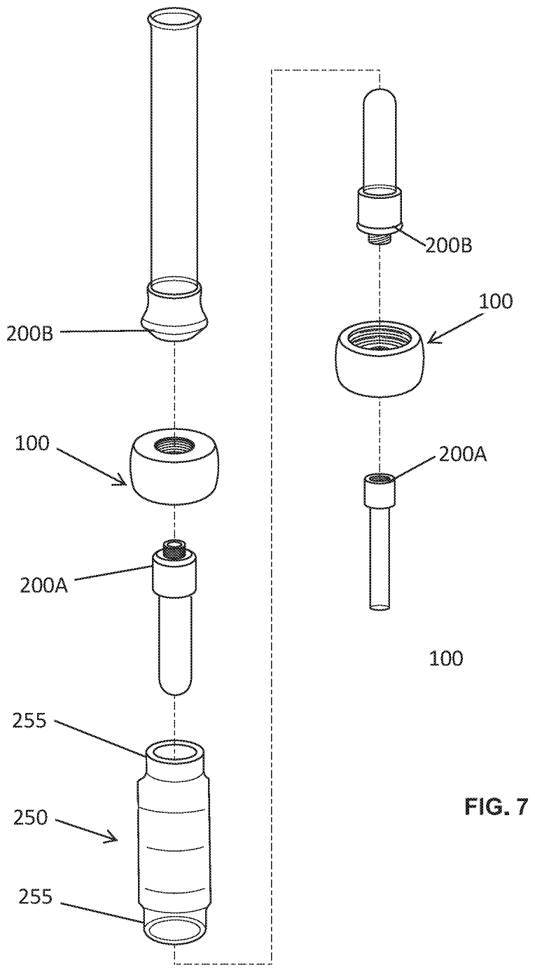

Referring now to FIGS. 1-7, there is shown in a first embodiment a collar 100 used to connect components together. The components may be assembled to create a hookah or waterpipe, but this is not the function of the invention, the function is to create a gas or liquid seal between the two components. In addition, the components have smooth ends, absent threads or beads, presenting a unique challenge in connecting two ends of two separate components together. Lastly, the components may be glass, plastic or other types of materials that have substantially smooth or straight ends, devoid of threads, beads or any type of connection means.

The function of the collar 100 is to maintain a frictional slip on and off connection (on one end) without threads or beads on the glass and a thread connection on the other end. The collar 100 has a base 110 with a circular side wall 120 extending from the base, to define a first opened end 105. The circular side wall 120 includes a pair of channels 130 and 135 spaced apart from each other at about an equal distance between the base 110 and the top end 142 of the side wall 120. A pair of O-rings 140 and 145 fit within the channels. During assembly, the end of the glass frictionally slips into the first opened end of the collar 100. The exterior surface 150 of the side wall may be bowed outwardly.

The base 110 includes a bore 160 that includes threads 165. The bore is centrally positioned on the base leaving a circular table 170 on the base between the side wall 120 and the perimeter of the bore 160. The interior well wall 175 around the bore 160 is also about a quarter of the distance of the full length of the side wall. This allows, if necessary a double opposing threaded connectors 200 to be secured into the collar as well as the frictional fitted glass components.

As illustrated, a glass connector tube 250 having a smooth tube end 255 is frictionally secured to the collar 100. In addition, a first threaded connector 200A is connected to a portion of the threaded bore 160 positioned on the inside of the side wall 120 and a second threaded connector 200B is connected to another portion of the threaded bore 160 positioned on the bottom 112 of the base 110 of the collar 100. The threaded connectors 200 are used to secure other glass components (also frictionally secured to the threaded connectors). In connectors between the collar to threaded connectors, an external O-ring can be used between the threaded connectors and the threaded bore 160. As further illustrated, multiple collars 100A and 100B can be incorporated into the completed assembly of a waterpipe or hookah. In these assemblies, the pair of internal O-rings not only secure the glass component in position, but also eliminate leaking of smoke or liquid.

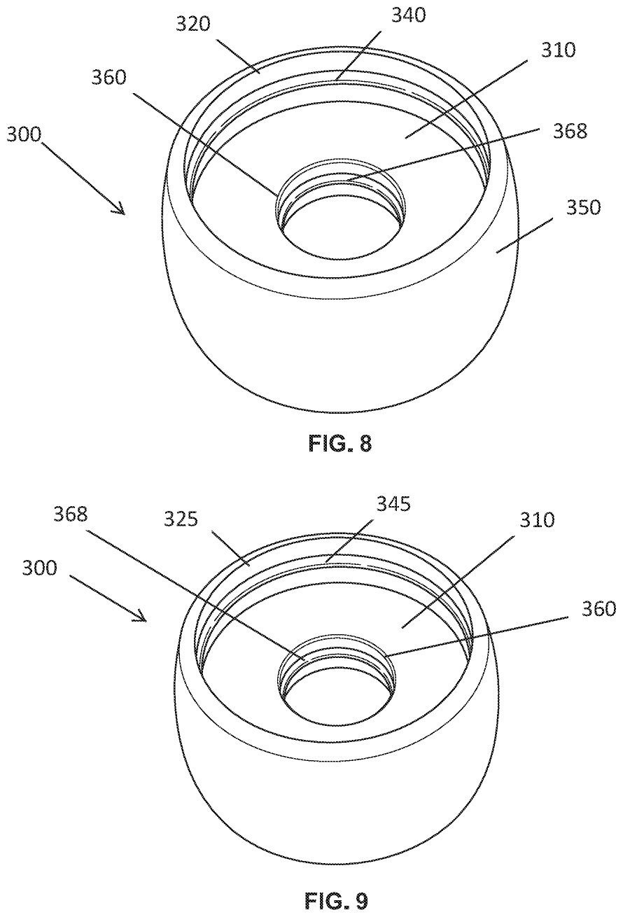

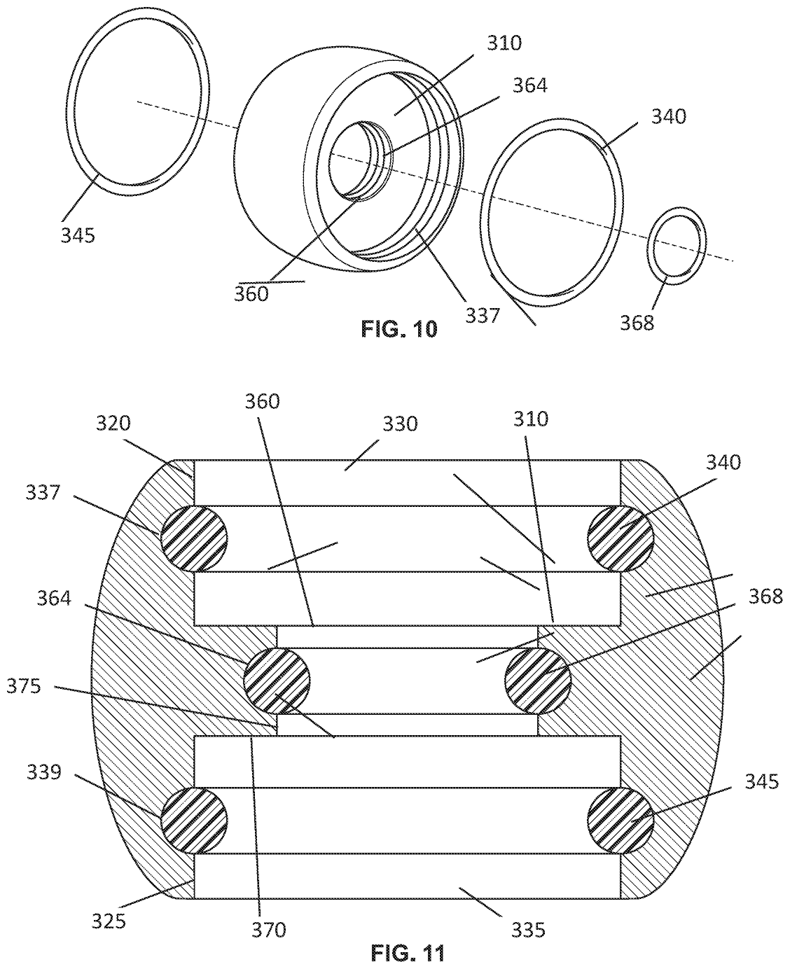

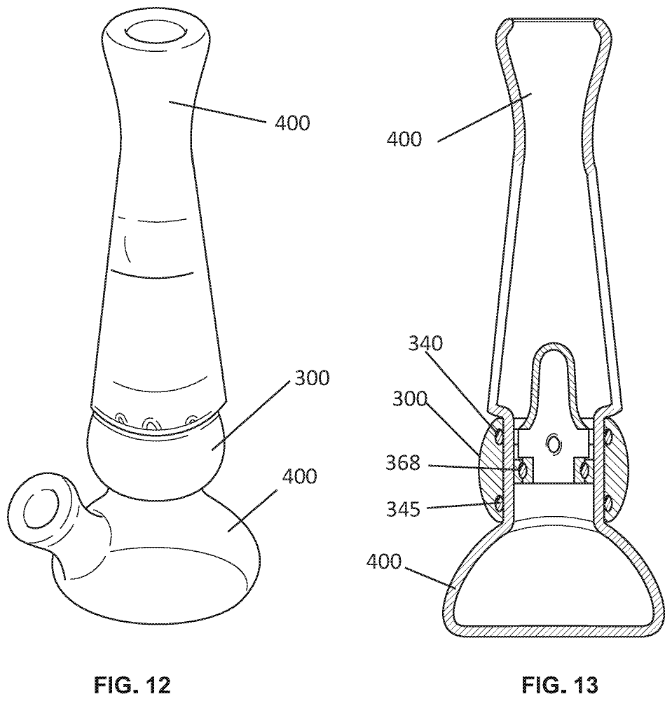

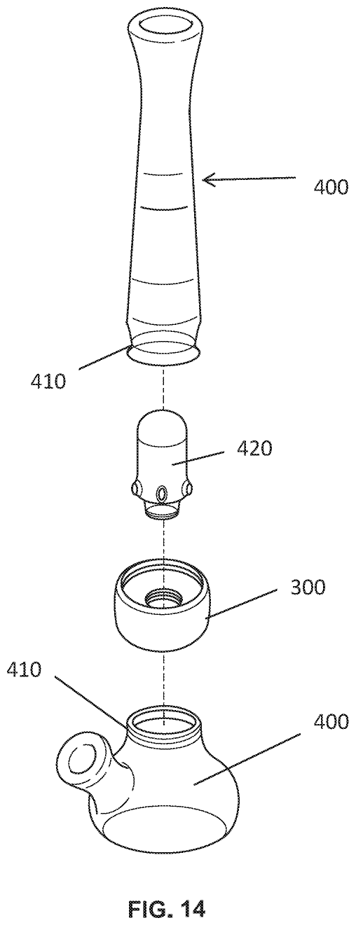

Referring now to FIGS. 8-14, there is shown in a second embodiment a collar 300 used to connect glass components to assist in the assembling of a hookah or waterpipe. The collar 300 has an internal base 310 with a first circular side wall 320 extending upwardly from the internal base and a second circular side wall 325 extending downwardly from the internal base, to define a first opened end 330 and a second opened end 335, respectively. The circular side walls 320 and 325 each include a channel 337 and 339 spaced along the side wall away from the internal base 310. An O-ring 340 and 345 are configured to fit within the channel. During assembly, the end of a glass component frictionally slips into the first opened end and second opened end of the collar 300. The exterior surface 350 of the side wall may be bowed outwardly.

The base 310 includes a bore 360 that includes a channel 364 and an O-ring 368 fitted therein. The bore 360 is centrally positioned on the base leaving a circular table 370 on the base between the side walls and the perimeter of the bore 360. The interior well wall 375 around the bore 360 is also about a quarter of the distance of the full length of the side wall.

As illustrated, a pair of glass containers 400 have smooth walled ends 410 that frictionally secured into the collar 300. As further illustrated, an internal glass container 420 may be secured within one of the glass containers by using the smaller bore connector defined by the collar 300. Once assembled, the user has a waterpipe or hookah. In these assemblies, the use of internal O-rings not only secure the glass component in position, but also eliminate leaking of smoke or liquid.

From the foregoing and as mentioned above, it is observed that numerous variations and modifications may be effected without departing from the spirit and scope of the novel concept of the invention. It is to be understood that no limitation with respect to the embodiments illustrated herein is intended or should be inferred. It is intended to cover, by the appended claims, all such modifications within the scope of the appended claims,

We claim:

1. A component collar to secure a glass component thereto, wherein the glass component has a smooth tubular end, the collar being configured to prevent a gas and liquid from leaking from the glass component, the collar comprising:
a base with a circular side wall extending from the base to define a first opened end;
a pair of channels grooved into an interior surface of the circular side wall;
a pair of O-rings separately secured within the pair of channels, the O-rings are configured in size such that when the smooth tubular end of the glass component frictionally slips into the first opened end of the collar, the pair of O-rings frictionally engages the smooth tubular end to prevent a leaking of gas or liquid; and
a bore defined through the base, the base surface wall surrounding the bore having threads to secure in concert with a one or more threaded connectors.

2. The component collar of claim 1, wherein the pair of channels are equally spaced apart at an equal distance between the base and a top end of the side wall.

3. The component collar of claim 1, wherein the bore is about a quarter of the distance of the full length of the side wall configured to accommodate double opposing threaded connectors that are secured into the bore.

4. The component collar of claim 3, wherein the bore is centrally positioned on the base leaving a circular table on the base between the side wall and the perimeter of the bore.

5. A component collar to secure components thereto, wherein the components have at least one tubular end configured to have a substantially smooth exterior profile, the collar being configured to prevent a gas and liquid from leaking from the components when two components are assembled together with the collar, the collar comprising:
a base with a first circular side wall extending upwardly from the base to define a first opened end and a second circular side wall extending downwardly from the base to define a second opened end;
a side wall channel grooved into each of the first and second circular side walls;
a bore defined through the base, a base surface wall surrounding the bore having a bore channel grooved into the base surface wall;
an O-ring secured within each of the side wall channels and the bore channel, the O-rings are configured in size such that when smooth exterior profile ends of separate components frictionally slip into the first opened end, the second opened end, and the bore defined by the collar, the O-rings frictionally engages the smooth exterior profile ends to prevent gas or liquid from leaking between the separate components.

6. The component collar of claim 5, wherein the bore is centrally positioned on the base leaving a circular table on the base between the side wall and the perimeter of the bore.

7. A component collar to secure a glass component thereto, wherein the glass component has a smooth tubular end, the collar being configured to prevent a gas and liquid from leaking from the glass component, the collar comprising:
a base with a first circular side wall extending upwardly from the base to define a first opened end;
at least one channel grooved into an interior surface of the first circular side wall;
an O-ring separately secured within each of the at least one channel, each O-ring is configured in size such that when the smooth tubular end of the glass component frictionally slips into the first opened end of the collar, each O-ring frictionally engages the smooth tubular end to prevent a leaking of gas or liquid; and
a bore defined through the base, a base surface wall surrounding the bore having a means to secure a glass component that further is configured to prevent leaking of gas or liquid.

8. The collar of claim 7, wherein the at least one channel is defined to include a pair of channels, each having a separate O-ring.

9. The collar of claim 8, wherein the means to secure a glass component that further is configured to prevent leaking of gas or liquid is further defined as having threads to secure in concert with a one or more threaded connectors.

10. The collar of claim 7 further comprising:
a second circular side wall extending downwardly from the base to define a second opened end;
at least one channel grooved into an interior surface of the second circular side wall;
an O-ring separately secured within each of the at least one channel, each O-ring is configured in size such that when the smooth tubular end of the glass component frictionally slips into the second opened end of the collar, each O-ring frictionally engages the smooth tubular end to prevent a leaking of gas or liquid.

11. The collar of claim 10, wherein the means to secure a glass component that further is configured to prevent leaking of gas or liquid is further defined as having a bore channel grooved into the base surface wall and an O-ring secured within the bore channel, the O-ring being configured in size such that when a smooth tubular end of a glass component frictionally slip into the bore, the O-rings frictionally engages the smooth tubular end to prevent a leaking of gas or liquid.
